(19) United States
(12) Patent Application Publication
(10) Pub. No.: US 2012/0072499 A1
(43) Pub. Date: Mar. 22, 2012

(54) SYSTEM AND METHOD FOR THE CONTROL AND MANAGEMENT OF MULTIPOINT CONFERENCE

(75) Inventors: Stephen Cipolli, Nanuet, NJ (US); Jonathan Lennox, Jersey City, NJ (US); Sreeni Nair, East Brunswick, NJ (US); Balasubramanian Pitchandi, Hackensack, NJ (US); Roi Sasson, New York, NY (US); Manoj Saxena, Monroe Township, NJ (US)

(73) Assignee: VIDYO, INC., Dallas, TX (US)

(21) Appl. No.: 13/237,903

(22) Filed: Sep. 20, 2011

Related U.S. Application Data
(60) Provisional application No. 61/384,634, filed on Sep. 20, 2010.

(51) Int. Cl. G06F 15/16

(52) U.S. Cl. 709/204

(57) ABSTRACT

Systems and methods for the control and management of multipoint conferences are disclosed herein, where endpoints can selectively and individually manage the streams that will be transmitted to them. Techniques are described that allow a transmitting endpoint to collect information from other receiving endpoints, or aggregated such information from servers, and process them into a single set of operating parameters that it then uses for its operation. Algorithms are described for performing conference-level show, on-demand show, show parameter aggregation and propagation, propagation of notifications. Parameters identified for describing sources in show requests include bit rate, window size, pixel rate, and frames per second.

### CROSS-REFERENCE TO RELATED APPLICATIONS

This application claims the benefit of United States provisional patent application Ser. No. 61/384,634, filed Sep. 20, 2010, which is incorporated by reference herein in its entirety.

### FIELD

The present application relates to the management and control of multipoint conferences. In particular, it relates to mechanisms for adding or removing participants in a multipoint conference that may involve zero, one, or more servers, selectively and dynamically receiving content or specific content types from other participants, receiving notifications regarding changes in the state of the conference, etc.

### BACKGROUND

The field of audio and video communication and conferencing has experienced a significant growth over the past three decades. The availability of the Internet, as well as continuous improvements in audio and video codec design have resulted in a proliferation of audio or video-based services. Today, there are systems and services that enable one to conduct point-to-point as well as multi-point communication sessions using audio, video with audio, as well as multimedia (e.g., video, audio, and presentations) from anywhere in the world there is an Internet connection. Some of these services are based on publicly available standards (e.g., SIP, H.323, XMPP), whereas others are proprietary (e.g., Skype). These systems and services are often offered through an Instant Messaging (‘IM’) solution, i.e., a system that allows users to see if other users are online (the so-called “presence” feature) and conduct text chats with them. Audio and video become additional features offered by the application. Other systems focus exclusively on video and audio (e.g., Vidyo's VidyoDesktop), assuming that a separate system will be used for the text chatting feature.

The availability of these communication systems has resulted in the availability of mature specifications for signaling in these systems. For example, SIP, H.323, and also XMPP, are widely used facilities for signaling: setting up and tearing down sessions, negotiating system parameters between transmitters and receivers, and managing presence information or transmitting structured data. SIP is defined in RFC 3261, Recommendation H.323 is available from the International Telecommunications Union, and XMPP is defined in RFCs 6120, 6121, and 6122 as well as XMPP extensions (XEPs) produced by the XMPP Standards Foundation; all references are incorporated herein by reference in their entirety.

These architectures have been designed with a number of assumptions in terms of how the overall system is supposed to work. For systems that are based on (i.e., originally designed for) audio or audiovisual communication, such as SIP or H.323, the designers assumed a more or less static configuration of how the system operates: encoding parameters such as video resolutions, frame rates, bit rates, etc., are set once and remain unchanged for the duration of the session. Any changes require essentially a re-establishment of the session (e.g., SIP re-invites), as modifications were not anticipated nor allowed after the connection is setup and media has started to flow through the connection.

Recent developments, however, in codec design, and particularly video codec design, have introduced effective so-called “layered representations.” A layered representation is such that the original signal is represented at more than one fidelity levels using a corresponding number of bitstreams.

One example of a layered representation is scalable coding, such as the one used in Recommendation H.264 Annex G (Scalable Video Coding—SVC), available from the International Telecommunications Union and incorporated herein by reference in its entirety. In scalable coding such as SVC, a first fidelity point is obtained by encoding the source using standard non-scalable techniques (e.g., using H.264 Advanced Video Coding—AVC). An additional fidelity point can be obtained by encoding the resulting coding error (the difference between the original signal and the decoded version of the first fidelity point) and transmitting it in its own bitstream. This pyramidal construction is quite common (e.g., it was used in MPEG-2 and MPEG-4 Part 3 video).

The first (lowest) fidelity level bitstream is referred to as the base layer, and the bitstreams providing the additional fidelity points are referred to as enhancement layers. The fidelity enhancement can be in any fidelity dimension. For example, for video it can be temporal (frame rate), quality (SNR), or spatial (picture size). For audio, it can be temporal (samples per second), quality (SNR), or additional channels. Note that the various layer bitstreams can be transmitted separately or, typically, can be transmitted multiplexed in a single bitstream with appropriate information that allows the direct extraction of the sub-bitstreams corresponding to the individual layers.

Another example of a layered representation is multiple description coding. Here the construction is not pyramidal: each layer is independently decodable and provides a representation at a basic fidelity; if more than one layer is available to the decoder, however, then it is possible to provide a decoded representation of the original signal at a higher level of fidelity. One (trivial) example would be transmitting the odd and even pictures of a video signal as two separate bitstreams. Each bitstream alone offers a first level of fidelity, whereas any information received from other bitstreams can be used to enhance this first level of fidelity. If all streams are received, then there is a complete representation of the original at the maximum level of quality afforded by the particular representation.

Yet another extreme example of a layered representation is simulcasting. In this case, two or more independent representations of the original signal are encoded and transmitted in their own streams. This is often used, for example, to transmit Standard Definition TV material and High Definition TV material. It is noted that simulcasting is a special case of scalable coding where no inter-layer prediction is used.

Transmission of video and audio in IP-based networks typically uses the Real-Time Protocol (RTP) as the transport protocol (RFC 3550, incorporated herein by reference in its entirety). RTP operates typically over UDP, and provides a number of features needed for transmitting real-time content, such as payload type identification, sequence numbering, time stamping, and delivery monitoring. Each source transmitting over an RTP session is identified by a unique SSRC (Synchronization Source). The packet sequence number and timestamp of an RTP packet are associated with that particular SSRC.

When layered representations of audio or video signals are transmitted over packet-based networks, there are advantages when each layer (or groups of layers) is transmitted over its own connection, or session. In this way, a receiver that only wishes to decode the base quality only needs to receive the particular session, and is not burdened by the additional bit rate required to receive the additional layers. Layered multicast is a well-known application that uses this architecture. Here the source multicasts the content's layers over multiple multicast channels, and receivers “subscribe” only to the layer channels they wish to receive. In other applications such as videoconferencing it may be preferable, however, if all the layers are transmitted multiplexed over a single connection. This makes it easier to manage in terms of firewall traversal, encryption, etc. For multi-point systems, it may also be preferable that all video streams are transmitted over a single connection.

Layered representations have been used in commonly assigned U.S. Pat. No. 7,593,032, “System and Method for a Conference Server Architecture for Low Delay and Distributed Conferencing Applications”, issued Sep. 22, 2009, in the design of a new type of Multipoint Control Unit (‘MCU’) which is called Scalable Video Coding Server (‘SVCS’). The SVCS introduces a completely new architecture for video communication systems, in which the complexity of the traditional transcoding MCU is significantly reduced. Specifically, due to the layered structure of the video data, the SVCS performs just selective forwarding of packets in order to offer personalized layout and rate or resolution matching. Due to the lack of signal processing, the SVCS introduces very little delay. All this, in addition to other features such as greatly improved error resilience, have transformed what is possible today in terms of the quality of the visual communications experience. Commonly assigned International Patent Applications Nr. PCT/US06/061815, “Systems and Methods for Error Resilience and Random Access in Video Communication Systems”, filed Dec. 8, 2006, and Nr. PCT/US07/63335, “System and Method for Providing Error Resilience, Random Access, and Rate Control in Scalable Video Communications,” filed Mar. 5, 2007, both incorporated herein by reference in their entirety, describe specific error resilience, random access, and rate control techniques for layered video representations. Existing signaling protocols have not been designed to take into account the system features that layered representations make possible. For example, with a layered representation, it is possible to switch the video resolution of a stream in the same session, without having to re-establish the session. This is used, for example, in commonly assigned International Patent Application PCT/US09/046758, “System and Method for Improved View Layout Management in Scalable Video and Audio Communication Systems,” filed Jun. 9, 2009, incorporated herein in its entirety. In the same application there is a description of an algorithm in which videos are added or removed from a layout depending on speaker activity. These functions require that the endpoint, where compositing is performed, can indicate to the SVCS which streams it wishes to receive and with what properties (e.g., resolution).

### SUMMARY

Disclosed herein are techniques for the control and management of multipoint conferences where endpoints can selectively and individually manage the streams that will be transmitted to them. In some embodiments, the disclosed subject matter allows a transmitting endpoint to collect information from other receiving endpoints and process them into a single set of operating parameters that it then uses for its operation. In another embodiment the collection is performed by an intermediate server, which then transmits the aggregated data to the transmitting endpoint. In one or more embodiments, the disclosed subject matter uses conference-level show, the on-demand show, show parameter aggregation and propagation, the notify propagation for cascaded (or meshed) operation, and show parameter hints (such as bit rate, window size, pixel rate, fps).

### BRIEF DESCRIPTION OF THE DRAWINGS

FIG. 1 shows a system diagram of an audiovisual communication system with multiple participants and multiple servers, in accordance with an embodiment of the disclosed subject matter;

FIG. 2 shows a diagram of the system modules and associated protocol components in a client and a server, in accordance with an embodiment of the disclosed subject matter;

FIG. 3 depicts an exemplary CMCP message exchange for a client-initiated join and leave operation, in accordance with an aspect of the disclosed subject matter;

FIG. 4 depicts an exemplary CMCP message exchange for a client-initiated join and server-initiated leave operation, in accordance with an aspect of the disclosed subject matter;

FIG. 5 depicts an exemplary CMCP message exchange for performing self-view, in accordance with an aspect of the disclosed subject matter;

FIG. 6 depicts an exemplary conference setup that is used for the analysis of the cascaded CMCP operation, in accordance with an aspect of the disclosed subject matter;

FIG. 7 depicts the process of showing a local source in a cascaded configuration, in accordance with an aspect of the disclosed subject matter;

FIG. 8 depicts the process of showing a remote source in a cascaded configuration, in accordance with an aspect of the disclosed subject matter;

FIG. 9 depicts the process of showing a “selected” source in a cascaded configuration, in accordance with an embodiment of the disclosed subject matter; and

FIG. 10 is a block diagram of a computer system suitable for implementing embodiments of the current disclosure.

Throughout the figures the same reference numerals and characters, unless otherwise stated, are used to denote like features, elements, components or portions of the illustrated embodiments. Moreover, while the disclosed subject matter will now be described in detail with reference to the figures, it is being done so in connection with the illustrative embodiments.

### DETAILED DESCRIPTION

The disclosed subject matter describes a technique for managing and controlling multipoint conferences which is referred to as the Conference Management and Control Protocol (‘CMCP’). It is a protocol to control and manage membership in multimedia conferences, the selection of multimedia streams within conferences, and the choice of characteristics by which streams are received.

CMCP is a protocol for controlling focus-based multi-point multimedia conferences. A ‘focus’, or server, is an MCU (Multipoint Control Unit), SVCS (as explained above), or other Media-Aware Network Element (MANE). Other protocols (SIP, Jingle, etc.) are used to set up multimedia sessions between an endpoint and a server. Once a session is established, it can be used to transport streams associated with one or more conferences.

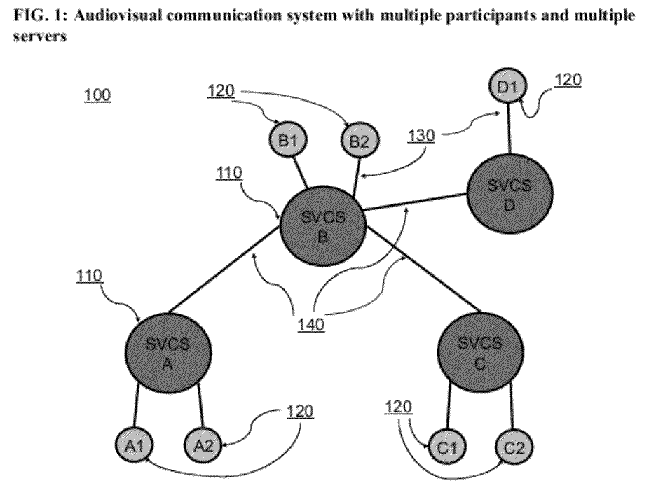

FIG. 1 depicts the general architecture of an audiovisual communication system 100 in accordance with an embodiment of the disclosed subject matter. The system features a number of servers 110 and endpoints 120. By way of example, the figure shows 7 endpoints and 4 servers; any number of endpoints and servers can be accommodated. In some embodiments of the disclosed subject matter the servers are SVCSs, whereas in other embodiments of the disclosed subject matter the servers may be MCUs (switching or transcoding), a gateway (e.g., a VidyoGateway) or any other type of server. FIG. 1 depicts all servers 110 as SVCSs. An example of an SVCS is the commercially available VidyoRouter.

The endpoints may be any device that is capable of receiving/transmitting audio or video data: from a standalone room system (e.g., the commercially available VidyoRoom 220), to a general purpose computing device running appropriate software (e.g., a computer running the commercially available VidyoDesktop software), a phone or tablet device (e.g., an Apple iPhone or iPad running VidyoMobile), etc. In some embodiments some of the endpoints may only be transmitting media, whereas some other endpoints may only be receiving media. In yet another embodiment some endpoints may even be recording or playback devices (i.e., without a microphone, camera, or monitor).

Each endpoint is connected to one server. Servers can connect to more than one endpoint and to more than one server. In some embodiments of the disclosed subject matter an endpoint can be integrated with a server, in which case that endpoint may be connecting to more than one server and/or other endpoints.

With continued reference to FIG. 1, the servers 110 are shown in a cascaded configuration: the path from one endpoint to another traverses more than one server 110. In some embodiments there may be a single server 110 (or no server at all, if its function is integrated with one or both of the endpoints).

Each endpoint-to-server connection 130 or server-to-server connection 140 is a session, and establishes a point-to-point connection for the transmission of RTP data, including audio and video. Note that more than one stream of the same type may be transported through each such connection. One example is when an endpoint receives video from multiple participants through an SVCS-based server. Its associated server would transmit all the video streams to the endpoint through a single session. An example using FIG. 1 would be video from endpoints B1 and B2 being transmitted to endpoint A1 through servers SVCS B and SVCS A. The session between endpoint A1 and server SVCS A would carry both of the video streams coming from B1 and B2 (through server SVCS B). In another embodiment the server may establish multiple sessions, e.g., one each for each video stream. A further example where multiple streams may be involved is an endpoint with multiple video sources. Such an endpoint would transmit multiple videos over the session it has established with its associated server.

Both the endpoints 120 and the servers 110 run appropriate software to perform signaling and transport functions. In one embodiment these components may be structured as plug-ins in the overall system software architecture used in each component (endpoint or server). In one embodiment the system software architecture is based on a Software Development Kit (SDK) which incorporates replaceable plug-ins performing the aforementioned functions.

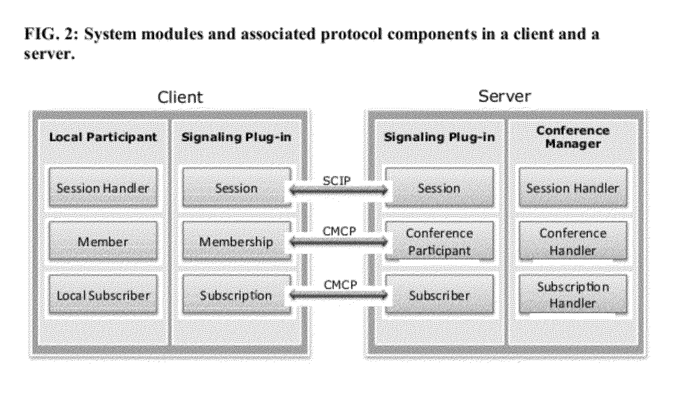

The logical organization of the system software in each endpoint 120 and each server 110 in some embodiments of the disclosed subject matter is shown in FIG. 2. There are three levels of functionality: session, membership, and subscription. Each is associated with a plug-in component as well as a handling abstraction.

The session level involves the necessary signaling operations needed to establish sessions. In some embodiments the signaling may involve standards-based signaling protocols such as XMPP or SIP (possibly with the use of PRACK, defined in RFC 3262, “Reliability of provisional responses in the Session Initiation Protocol”, incorporated herein by reference in its entirety). In some embodiments the signaling may be proprietary, such as using the SCIP protocol. SCIP is a protocol with a state machine essentially identical to XMPP and SIP (in fact, it is possible to map SCIP's messages to SIP one-to-one). In FIG. 2 it is shown that the SCIP protocol is used. For the purposes of the disclosed subject matter, the exact choice of signaling protocol is irrelevant.

With continued reference to FIG. 2, the second level of functionality is that of conference membership. A conference is a set of endpoints and servers, together with their associated sessions. Note that the concept of a session is distinct from that of a conference and, as a result, one session can be part of more than one conferences. This allows an endpoint (and of course a server) to be part of more than one conference. The membership operations in embodiments of the disclosed subject matter are performed by functions in the CMCP protocol. They include operations such as “join” and “leave” for entering and leaving conferences, as well as messages for instructing an endpoint or server to provide a media stream with desired characteristics. These functions are detailed later on.

Finally, with continued reference to FIG. 2, the third level of functionality deals with subscriptions. Subscriptions are also part of the CMCP protocol, and are modeled after the subscribe/notify operation defined for SIP (RFC 3265, “Session Initiation Protocol (SIP)-Specific Event Notification,” incorporated herein by reference in its entirety). This mechanism is used in order to allow endpoints and servers to be notified when the status of the conferences they participate changes (a participant has left the conference, etc.).

We now describe the CMCP protocol and its functions in detail. In some embodiments of the disclosed subject matter CMCP allows a client to associate a session with conferences (ConferenceJoin and ConferenceLeave), to receive information about conferences (Subscribe and Notify), and to request specific streams, or a specific category of streams, in a conference (ConferenceShow and ConferenceShowSelected).

CMCP has two modes of operation: between an endpoint and a server, or between two servers. The latter mode is known as cascaded or “meshed” mode and is discussed later on.

CMCP is designed to be transported over a variety of possible methods. In one embodiment it can be transported over SIP. In another embodiment of the disclosed subject matter it is transported over SCIP Info messages (similar to SIP Info messages). In one embodiment CMCP is encoded as XML and its syntax is defined by an XSD schema. Other means of encoding are of course possible, including binary ones, or compressed.

In some embodiments, when CMCP is to be used to control a multimedia session, the session establishment protocol negotiates the use of CMCP and how it is to be transported. All the CMCP messages transported over this CMCP session describe conferences associated with the corresponding multimedia session.

In one embodiment of the disclosed subject matter CMCP operates as a dialog-based request/response protocol. Multiple commands may be bundled into a single request, with either execute-all or abort-on-first-failure semantics. If commands are bundled, replies are also bundled correspondingly. Every command is acknowledged with either a success response or an error status; some commands also carry additional information in their responses, as noted.

The ConferenceJoin method requests that a multimedia session be associated with a conference. It carries as a parameter the name, or other suitable identifier, of the conference to join. In an endpoint-based CMCP session, it is always carried from the endpoint to the server.

In some embodiments, the ConferenceJoin message may also carry a list of the endpoint's sources (as specified at the session level) that the endpoint wishes to include in the conference. If this list is not present, all of the endpoint's current and future sources are available to the conference.

The protocol-level reply to a ConferenceJoin command carries only an indication of whether the command was successfully received by the server. Once the server determines whether the endpoint may actually join the conference, it sends the endpoint either a ConferenceAccept or ConferenceReject command.

ConferenceJoin is a dialog-establishing command. The ConferenceAccept and ConferenceReject commands are sent within the dialog established by the ConferenceJoin. If ConferenceReject is sent, it terminates the dialog created by the ConferenceJoin.

The ConferenceLeave command terminates the dialog established by a ConferenceJoin, and removes the endpoint's session from the corresponding conference. In one embodiment of the disclosed subject matter, and for historical and documentation reasons, it carries the name of the conference that is being left; however, as an in-dialog request, it terminates the connection to the conference that was created by the dialog-establishing ConferenceJoin.

ConferenceLeave carries an optional status code indicating why the conference is being left.

The ConferenceLeave command may be sent either by the endpoint or by the server.

The Subscribe command indicates that a CMCP client wishes to receive dynamic information about a conference, and to be updated when the information changes. The Notify command provides this information when it is available. As mentioned above, it is modeled closely on SIP SUBSCRIBE and NOTIFY.

A Subscribe command carries the resource, package, duration, and, optionally, suppressIfMatch parameters. It establishes a dialog. The reply to Subscribe carries a duration parameter which may adjust the duration requested in the Subscribe.

The Notify command in one embodiment is sent periodically from a server to client, within the dialog established by a Subscribe command to carry the information requested in the Subscribe. It carries the resource, package, eTag, and event parameters; the body of the package is contained in the event parameter. eTag is a unique tag that indicates the version of the information—it's what is placed in the suppressIfMatch parameter of a Subscribe command to say “I have version X, don't send it again if it hasn't changed”. This concept is taken from RFC 5389, “Session Traversal Utilities for NAT (STUN),” incorporated herein by reference in its entirety.

The Unsubscribe command terminates the dialog created by the Subscribe command.

In one embodiment of the disclosed subject matter the Participant and Selected Participant CMCP Packages are defined.

The Participant Package distributes a list of the participants within a conference, and a list of each participant's media sources.

A participant package notification contains a list of conference participants. Each participant in the list has a participant URI, human-readable display text, information about its endpoint software, and a list of its sources.

Each source listed for a participant indicates: its source ID (the RTP SSRC which will be used to send its media to the endpoint); its secondary source ID (the RTP SSRC which will be used for retransmissions and FEC); its media type (audio, video, application, text, etc.); its name; and a list of generic attribute/value pairs. In one embodiment the spatial position of a source is used as an attribute, if a participant has several related sources of the same media type. One such example is a telepresence endpoint with multiple cameras.

A participant package notification can be either a full or a partial update. A partial update contains only the changes from the previous notification. In a partial update, every participant is annotated with whether it is being added, updated, or removed from the list.

The Selected Participant Package distributes a list of the conference's “selected” participants. Selected Participants are the participants who are currently significant within the conference, and change rapidly. Which participants are selected is a matter of local policy of the conference's server. In one embodiment of the disclosed subject matter it may be the loudest speaker in the conference.

A Selected Participant Package update contains a list of current selected participants, as well as a list of participants who were previously selected (known as the previous “generations” of selected participants). In one embodiment of the disclosed subject matter 16 previous selected participant are listed. As is obvious to persons skilled in the art any other smaller or larger number may be used. Each selected participant is identified by its URI, corresponding to its URI in the participant package, and lists its generation numerically (counting from 0). A participant appears in the list at most once; if a previously-selected participant becomes once again selected, it is moved to the top of the list.

In one embodiment of the disclosed subject matter the Selected Participant Package does not support partial updates; each notification contains the entire current selected participant list. This is because the size of the selected participant list is typically small. In other embodiments it is possible to use the same partial update scheme used in the Participant Package.

In one embodiment the ConferenceShow command is used to request a specific (“static”) source to be sent to the endpoint, as well as optional parameters that provide hints to help the server know how the endpoint will be rendering the source.

In one embodiment of the disclosed subject matter the ConferenceShow can specify one of three modes for a source: “on” (send always); “auto” (send only if selected); or “off” (do not send, even if selected—i.e., blacklist) Sources start in the “auto” state if no ConferenceShow command is ever sent for them. Sources are specified by their (primary) source ID values, as communicated in the Participant Package.

ConferenceShow also includes optional parameters providing hints about the endpoint's desires and capabilities of how it wishes to receive the source. In one embodiment the parameters include: windowSize, the width and height of the window in which a video source is to be rendered; framesPerSec, the maximum number of frames per second the endpoint will use to display the source; pixelRate, the maximum pixels per second the endpoint wishes to decode for the source; and preference, the relative importance of the source among all the sources requested by the endpoint. The server may use these parameters to decide how to shape the source to provide the best overall experience for the end system, given network and system constraints. The windowSize, framesPerSec, and pixelRate parameters are only meaningful for video (and screen/application capture) sources. It is here that the power of H.264 SVC comes into play, as it provides several ways in which the signal can be adapted after encoding has taken place. This means that a server can use these parameters directly, and it does not necessarily have to forward them to the transmitting endpoint. It is also possible that the parameters are forwarded to the transmitting endpoint.

Multiple sets of parameters may be merged into a single one for propagation to another server (for meshed operation). For example, if 15 fps and 30 fps are requested from a particular server, that server can aggregate the requests into a single 30 fps request. As is obvious to those skilled in the art, any number and type of signal characteristics can be used as optional parameters in a ConferenceShow. It is also possible in some embodiments to use ranges of parameters, instead of distinct values, or combinations thereof.

Commonly assigned International Patent Application No. PCT/US 11/021864, “Participant-aware configuration for video encoder,” filed Jan. 20, 2011, and incorporated herein by reference in its entirety, describes techniques for merging such parameters, including the case of encoders using the H.264 SVC video coding standard.

In one embodiment of the disclosed subject matter each ConferenceShow command requests only a single source. However, as mentioned earlier, multiple CMCP commands may be bundled into a single CMCP request.

In some embodiments of the disclosed subject matter the ConferenceShow command is only sent to servers, never to endpoints. Server-to-endpoint source selection is done using the protocol that established the session. In the SIP case this can be done using RFC 5576, “Source-Specific Media Attributes in the Session Description Protocol,” and Internet-Draft “Media Source Selection in the Session Description Protocol (SDP)” (draft-lennox-mmusic-sdp-source-selection-02, work in progress, Oct. 21, 2010), both incorporated herein by reference in their entirety.

In some embodiments the ConferenceShowSelected command is used to request that dynamic sources are to be sent to an endpoint, as well as the parameters with which the sources are to be viewed. It has two parts, video and audio, either of which may be present.

The ConferenceShowSelected command's video section is used to select the video sources to be received dynamically. It consists of a list of video generations to view, as well as policy choices about how elements of the selected participant list map to requested generations.

The list of selected generations indicates which selected participant generations should be sent to the endpoint. In one embodiment each generation is identified by its numeric identifier, and a state (“on” or “off”) indicating whether the endpoint wishes to receive that generation. As well, each generation lists its show parameters, which may be the same as for statically-viewed sources: windowSize, framesPerSec, pixelRate, and preference. A different set of parameters may also be used.

Selected participant generations which are not listed in a ConferenceShowSelected command retain their previous state. The initial value is “off” if no ConferenceShowSelected command was ever sent for a generation.

In one embodiment, following the list of generations, the video section also specifies two policy values: the self-view policy and the dynamic-view policy.

The self-view policy specifies whether the endpoint's own sources should be routed to it when the endpoint becomes a selected participant. The available choices are “Hide Self” (the endpoint's sources are never routed to itself); “Show Self” (the endpoint's sources will always be routed to itself if it is a selected participant); and “Show Self If No Other” (the endpoint's sources are routed to itself only when it is the only participant in the conference). If the endpoint is in the list, subsequent generations requested in the ConferenceShowSelected are routed instead.

The dynamic-view policy specifies whether sources an endpoint is viewing statically should be counted among the generations it is viewing. The values are “Show If Not Statically Viewed” and “Show Even If Statically Viewed”; in one embodiment the latter is the default. In the former case, subsequent generations in the selected participant list are routed for the ConferenceShowSelected command.

In the “Show Even If Statically Viewed” case, if a source is both a selected participant and is being viewed statically, its preferences are the maximum of its static and dynamic preferences.

In one embodiment the ConferenceShowSelected command is only sent to servers, never to endpoints.

In one embodiment the ConferenceShowSelected command's audio section is used to select the audio sources to be received dynamically. It consists of the number of dynamic audio sources to receive, as well as a dynamic audio stream selection policy. It should include the audio selection policy of “loudestSpeaker”.

A ConferenceUpdate command is used to change the parameters sent in a ConferenceJoin. In particular, it is used if the endpoint wishes to change which of its sources are to be sent to a particular conference.

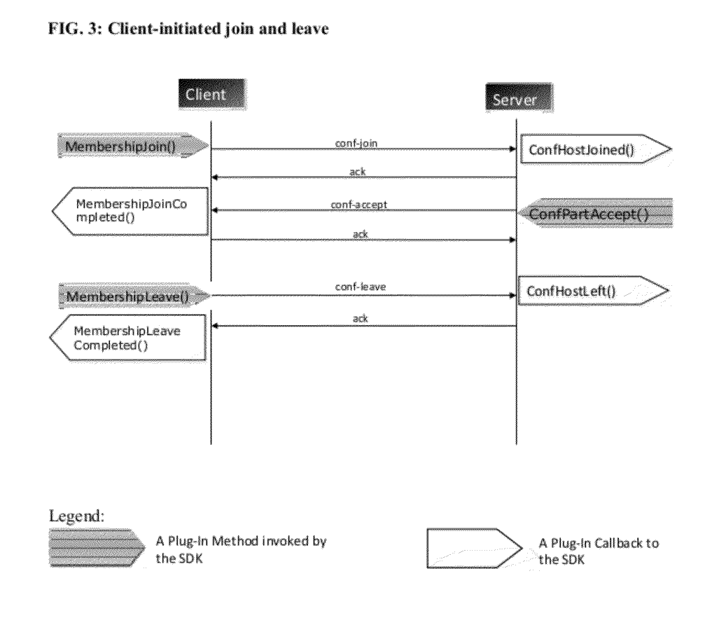

FIG. 3 shows the operation of the CMCP protocol between an endpoint (client) and a server for a client-initiated conference join and leave operation. In one embodiment of the disclosed subject matter we assume that the system software is built on an SDK. The message exchanges show the methods involved on the transmission side (plug-in methods invoked by the SDK) as well as the callbacks triggered on the reception side (plug-in callback to the SDK).

The transaction begins with the client invoking a MembershipJoin, which triggers a ConfHostJoined indicating the join action. Note that the “conf-join” message that is transmitted is acknowledged, as with all such messages. At some point, the server issued a ConfPartAccept indicating that the participant has been accepted into the conference. This will trigger a “conf-accept” message to the client, which in turn will trigger MembershipJoinCompleted to indicate the conclusion of the join operation. The client then issues a MembershipLeave, indicating its desire to leave the conference. The resulting “conf-leave” message triggers a ConfHostLeft callback on the server side and an “ack” message to the client. The latter triggers the indication that the leave operation has been completed.

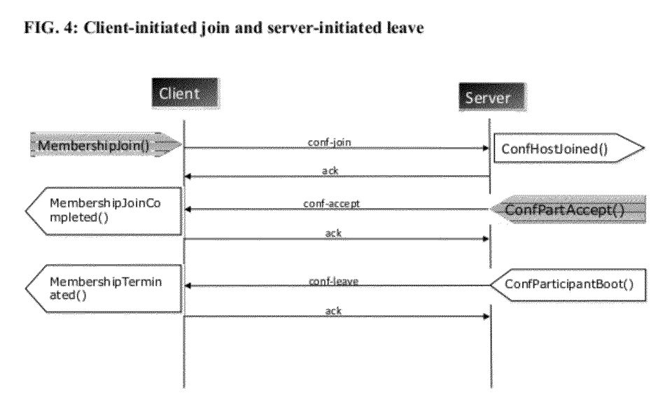

FIG. 4 shows a similar scenario. Here we have a client-initiated join and a server-initiated leave. The trigger of the leave operation is the ConfParticipantBoot method on the server side, which results in the MembershipTerminated callback at the client.

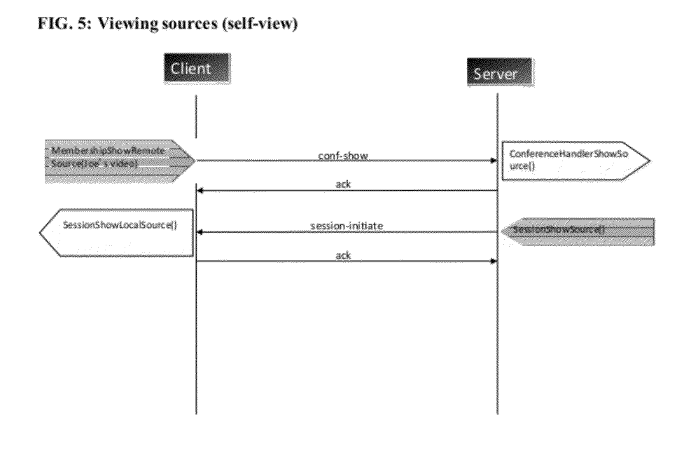

FIG. 5 shows the operations involved in viewing a particular source, in this case self viewing. In this embodiment, the client invokes MembershipShowRemoteSource, identifying the source (itself), which generates a “conf-show” message. This message triggers ConferenceHandlerShowSource, which instructs the conference to arrange to have this particular source delivered to the client. The conference handler will generate a SessionShowSource from the server to the client that can provides the particular source; in this example, the originator of the show request. The SessionShowSource will create a “session-initiate” message which will trigger a SessionShowLocalSource at the client to start transmitting the relevant stream. In some embodiments, media transmission does not start upon joining a conference; it actually starts when a server generates a show command to the client.

We now examine the operation of CMCP in cascaded or meshed configurations. In this case, more than one server is present in the path between two endpoints, as shown in FIG. 1. In general, any number of servers may be involved. In one embodiment when more than one server is involved, we will assume that each server has complete knowledge of the topology of the system through signaling means (not detailed herein). A trivial way to provide this information is through static configuration. Alternative means involve dynamic configuration by transmission of the graph information during each step that is taken to create it. We further assume that the connectivity graph is such that there are no loops, and that there is a path connecting each endpoint to every other endpoint. Alternative embodiments where any of these constraints may be relaxed are also possible, albeit with increased complexity in order to account for routing side effects.

The cascade topology information is used both to route media from one endpoint to another through the various servers, but also to propagate CMCP protocol messages between system components as needed.

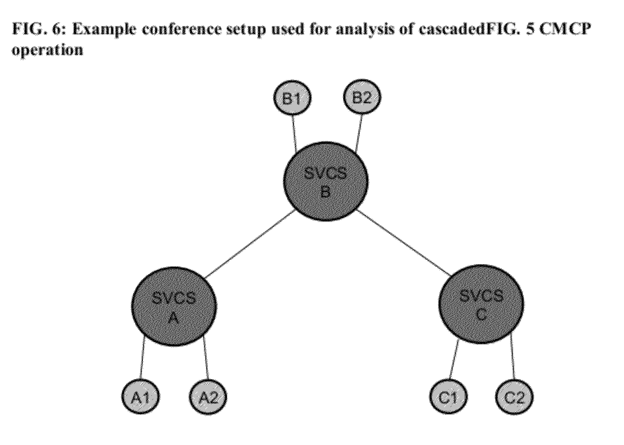

We will describe the operation of the CMCP protocol for cascaded configurations using as an example the conference configuration shown in FIG. 6. The conference 600 involves three servers 110 called “SVCS A” through “SVCS C”, with two endpoints 120 each (A1 and A2, B1 and B2, C1 and C2). Endpoints are named after the letter of the SVCS server they are assigned to (e.g., A1 and A2 for SVCS A). The particular configuration is not intended to be limiting and is only used by the way of example; the description provided can be applied on any topology.

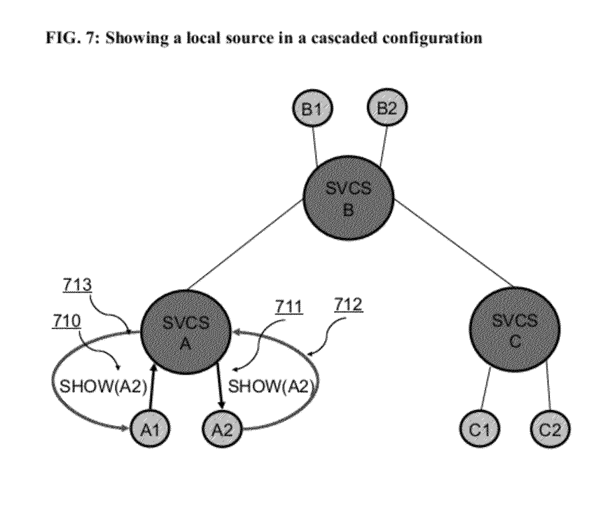

FIG. 7 shows the CMCP operations when a local show command is required. In this example, we will assume that endpoint A1 wishes to view endpoint A2. For visual clarity, we removed the session connections between the components; they are identical to the ones shown in FIG. 6. The straight arrow lines (e.g., 710) indicate transmission of CMCP messages. The curved arrow lines (e.g., 712) indicate transmission of media data.

As a first step, endpoint Al initiates a SHOW(A2) command 710 to its SVCS A. The SVCS A knows that endpoint A2 is assigned to it, and it forwards the SHOW(A2) command 711 to endpoint A2. Upon receipt, endpoint A2 starts transmitting its media 712 to its SVCS A. Finally, the SVCS A in turn forwards the media 713 to the endpoint Al. We notice how the SHOW( )command was propagated through the conference to the right sender (via SVCS A).

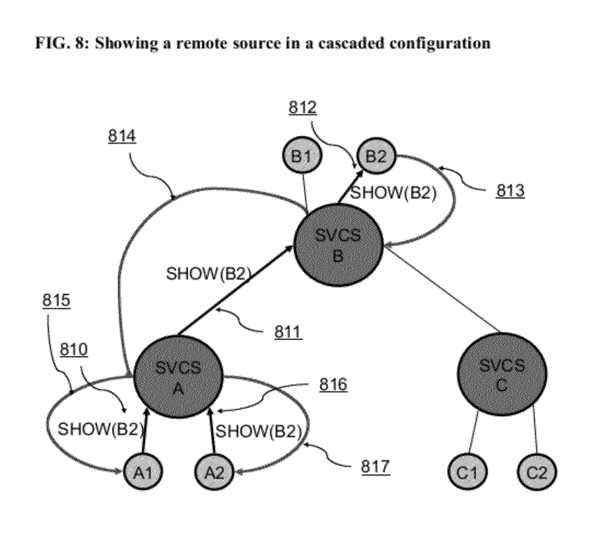

FIG. 8 shows a similar scenario, but now for a remote source. In this example we assume that endpoint Al wants to view media from endpoint B2. Again, as a first step endpoint Al issues a SHOW(B2) command 810 to its associated SVCS A. The SHOW( )command will be propagated to endpoint B2. This happens with the message SHOW(B2) 811 that is propagated from SVCS A to SVCS B, and SHOW(B2) 812 that is propagated from SVCS B to endpoint B2. Upon receipt, endpoint B2 starts transmitting media 813 to SVCS B, which forwards it through message 814 to SVCS A, which in turns forwards it through messasge 815 to endpoint Al which originally requested it. Again we notice how both the SHOW( )command, and the associated media, are routed through the conference. Since servers are aware of the conference topology, they can always route SHOW command requests to the appropriate endpoint. Similarly, media data transmitted from an endpoint is routed by its associated server to the right server(s) and endpoints.

Let's assume now that endpoint A2 also wants to see B2. It issues a SHOW(B2) command 816 to SVCS A. This time around the SHOW request does not have to be propagated back to SVCS B (and endpoint B) since SVCS A is already receiving the stream from B2. It can then directly start forwarding a copy of it as 817 to endpoint A2. If the endpoint A2 submits different requirements to SVCS A than endpoint A1 (e.g., a different spatial resolution), then the SVCS A can consolidate the performance parameters from both requests and propagate them back to B2 so that an appropriate encoder configuration is selected. This is referred to as “show aggregation.”

Aggregation can be in the form of combining two different parameter values into one (e.g., if one requests QVGA and one VGA, the server will combine them into a VGA resolution request), or it can involve ranges as well. An alternative aggregation strategy may trade-off different system performance parameters. For example, assume that a server receives one request for 720p resolution and 5 requests for 180p. Instead of combining them into a 720p request, it could select a 360p resolution and have the endpoint requesting 720p upscale. Other types of aggregations are possible as is obvious to persons skilled in the art, including majority voting, mean or median values, minimum and maximum values, etc.

If the server determines that a new configuration is needed it sends a new SessionShowSource command (see also FIG. 5). In another or the same embodiment, the server can perform such adaptation itself when possible.

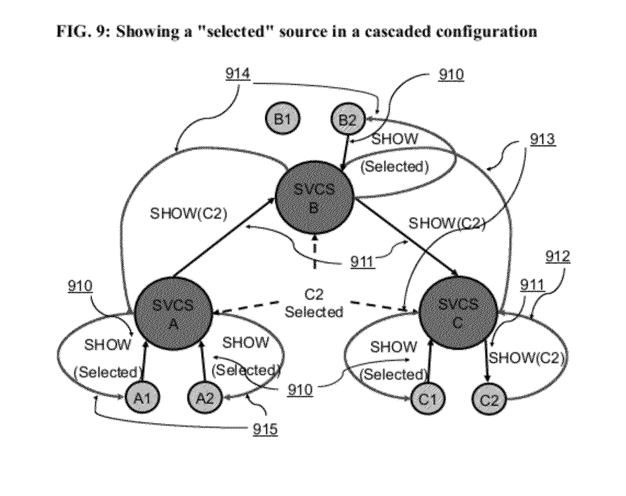

FIG. 9 shows a scenario with a selected participant (dynamic SHOW). In this example the endpoints do not know a priori which participant they want to see, as it is dynamically determined by the system. The determination can be performed in several ways. In one embodiment, each server can perform the determination by itself by examining the received media streams or metadata included with the streams (e.g., audio volume level indicators). In another embodiment the determination can be performed by another system component, such as a separate audio bridge. In yet another embodiment different criteria may be used for selection, such as motion.

With continued reference to FIG. 9, in a first step we assume that endpoints A1, A2, C1, and B2 transmit SHOW(Selected) commands 910 to their respective SVCSs. In one embodiment, using audio level indication or other means, the SVCSs determine that the selected participant is C2. In another embodiment the information is provided by an audio bridge that handles the audio streams. In alternative embodiments it is possible that more than one endpoint may be selected (e.g., N most recent speakers). Upon determination of the selected endpoint(s), the SVCSs A, B, and C transmit specific SHOW(C2) messages 911 specifically targeting endpoint C2. The messages are forward using the knowledge of the conference topology. This way, SVCS A sends its request to SVCS B, SVCS B sends its request to SVCS C, and SVCS sends its request to endpoint C2. Media data then flows from endpoint C2 through 912 to SVCS C, then through 913 to endpoint C1 and SVCS B, through 914 to endpoint B2 and SVCS A, and finally through 915 to endpoints A1 and A2.

A ConferenceInvite or ConferenceRefer command is used for server-to-endpoint communication to suggest to an endpoint that it join a particular conference.

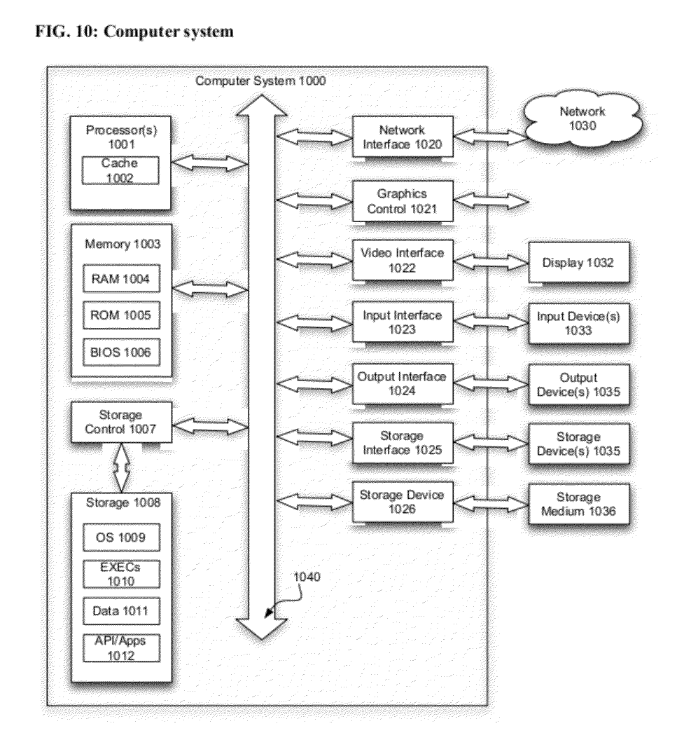

The methods for controlling and managing multipoint conferences described above can be implemented as computer software using computer-readable instructions and physically stored in computer-readable medium. The computer software can be encoded using any suitable computer languages. The software instructions can be executed on various types of computers. For example, FIG. 10 illustrates a computer system 500 suitable for implementing embodiments of the present disclosure.

The components shown in FIG. 10 for computer system 1000 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 1000 can have many physical forms including an integrated circuit, a printed circuit board, a small handheld device (such as a mobile telephone or PDA), a personal computer or a super computer.

Computer system 1000 includes a display 1032, one or more input devices 1033 (e.g., keypad, keyboard, mouse, stylus, etc.), one or more output devices 1034 (e.g., speaker), one or more storage devices 1035, various types of storage medium 1036.

The system bus 1040 link a wide variety of subsystems. As understood by those skilled in the art, a “bus” refers to a plurality of digital signal lines serving a common function. The system bus 1040 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 1001 (also referred to as central processing units, or CPUs) optionally contain a cache memory unit 1002 for temporary local storage of instructions, data, or computer addresses. Processor(s) 1001 are coupled to storage devices including memory 1003. Memory 1003 includes random access memory (RAM) 1004 and read-only memory (ROM) 1005. As is well known in the art, ROM 1005 acts to transfer data and instructions uni-directionally to the processor(s) 1001, and RAM 1004 is used typically to transfer data and instructions in a bi-directional manner. Both of these types of memories can include any suitable of the computer-readable media described below.

A fixed storage 1008 is also coupled bi-directionally to the processor(s) 1001, optionally via a storage control unit 1007. It provides additional data storage capacity and can also include any of the computer-readable media described below. Storage 1008 can be used to store operating system 1009, EXECs 1010, application programs 1012, data 1011 and the like and is typically a secondary storage medium (such as a hard disk) that is slower than primary storage. It should be appreciated that the information retained within storage 1008, can, in appropriate cases, be incorporated in standard fashion as virtual memory in memory 1003.

Processor(s) 1001 is also coupled to a variety of interfaces such as graphics control 1021, video interface 1022, input interface 1023, output interface, storage interface, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 1001 can be coupled to another computer or telecommunications network 1030 using network interface 1020. With such a network interface 1020, it is contemplated that the CPU 1001 might receive information from the network 1030, or might output information to the network in the course of performing the above-described method. Furthermore, method embodiments of the present disclosure can execute solely upon CPU 1001 or can execute over a network 1030 such as the Internet in conjunction with a remote CPU 1001 that shares a portion of the processing.

According to various embodiments, when in a network environment, i.e., when computer system 1000 is connected to network 1030, computer system 1000 can communicate with other devices that are also connected to network 1030. Communications can be sent to and from computer system 1000 via network interface 1020. For example, incoming communications, such as a request or a response from another device, in the form of one or more packets, can be received from network 1030 at network interface 1020 and stored in selected sections in memory 1003 for processing. Outgoing communications, such as a request or a response to another device, again in the form of one or more packets, can also be stored in selected sections in memory 1003 and sent out to network 1030 at network interface 1020. Processor(s) 1001 can access these communication packets stored in memory 1003 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 1000 can provide functionality as a result of processor(s) 1001 executing software embodied in one or more tangible, computer-readable media, such as memory 1003. The software implementing various embodiments of the present disclosure can be stored in memory 1003 and executed by processor(s) 1001. A computer-readable medium can include one or more memory devices, according to particular needs. Memory 1003 can read the software from one or more other computer-readable media, such as mass storage device(s) 1035 or from one or more other sources via communication interface. The software can cause processor(s) 1001 to execute particular processes or particular parts of particular processes described herein, including defining data structures stored in memory 1003 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It should also be noted that there are many alternative ways of implementing the methods and apparatuses of the disclosed subject matter.

What is claimed is:

1. An audiovisual communication system comprising:
one or more endpoints for transmitting or receiving media data over a communication network; and
one or more servers coupled to the one or more endpoints and to each other over the communication network, wherein the one or more servers are configured to:
upon receiving a request from a first of the one or more endpoints, directly or through the one or more servers, to provide media data from a second of the one or more endpoints, to forward the request to the second of the one or more endpoints, directly or through the one or more servers; and
upon receiving media data from the second of the one or more endpoints, directly or through the one or more servers, to forward the media data to the first of the one or more endpoints, directly or through the one or more servers, and wherein the one or more endpoints are configured to:
upon receiving the request from one of one or more endpoints to provide media data, to start transmitting media data to the one of the one or more endpoints that requested it, directly or through the one or more servers.

2. The system of claim 1 wherein the forwarding of the request and the forwarding of media data is performed according to routing information maintained by the one or more servers.

3. The system of claim 1 wherein the request includes one or more media parameters, and wherein the one or more endpoints are further configured to, upon receiving the request, use the parameters to adjust their transmitted media data.

4. The system of claim 3 wherein the one or more media parameters include at least one of window size, bit rate, pixel rate, and frames per second.

5. The system of claim 3 wherein the one or more servers are configured to combine multiple sets of received media parameters from requests that are to be forwarded to the same endpoint into a single set of media parameters, that is then forwarded to the endpoint.

6. An audiovisual communication system comprising:
one or more endpoints for transmitting or receiving media data over a communication network; and
one or more servers coupled to the one or more endpoints and to each other over the communication network,
wherein the one or more servers are configured to:
upon receiving a request from a first of the one or more endpoints, directly or through the one or more servers, to provide media data from a selected subset of the one or more endpoints, to apply the selection and forward media data from the selected subset of the one or more endpoints that it is currently receiving to the first of the one or more endpoints that requested it, directly or through the one or more servers.

7. The system of claim 6 wherein the one or more servers are further configured to, upon receiving a request, forward the request to other servers they are coupled to.

8. The system of claim 7 wherein the forwarding of the request is performed using routing information maintained by the one or more servers.

9. The system of claim 6 wherein the one or more servers are further configured to calculate the selected subset of the one or more endpoints.

10. The system of claim 9 wherein the calculation computes a list of one or more most recent active speakers.

11. The system of claim 6 wherein the one or more servers are further configured to obtain the calculation of the selected subset from external means.

12. The system of claim 11 wherein the external means is an audio bridge.

13. The system of claim 6 wherein the request includes one or more selection parameters.

14. The system of claim 13 wherein the selection parameters include the number of most recent active speakers.

15. A method for audiovisual communication, the method comprising at a server:
receiving a request from a first endpoint, directly or through another server, to provide media data from a second endpoint, and
forwarding the request to the second endpoint, directly or through another server,
receiving media data from the second endpoint, directly or through another servers, and
forwarding the media data to the first endpoint, directly or through the one or more servers.

16. The method of claim 15, the method further comprising at the second endpoint:
receiving the request from the first endpoint to provide media data, and
transmitting media data to the first endpoint, directly or through the one or more servers.

17. The method of claim 15 wherein forwarding of the request and forwarding of media data is performed according to routing information maintained by the server.

18. The method of claim 16 wherein the request includes one or more media parameters, and wherein the second endpoint is further configured to, upon receiving the request, use the parameters to adjust their transmitted media data.

19. The method of claim 18 wherein the one or more media parameters include one or more of window size, bit rate, pixel rate, or frames per second.

20. The method of claim 18 wherein the server is configured to combine multiple sets of received media parameters from requests that are to be forwarded to the second endpoint into a single set of media parameters, and then forward the single set to the said endpoint.

21. A method for audiovisual communications, the method comprising at a server:
receiving a request from a first endpoint, directly or through the another server, to provide media data from a selected subset of endpoints,
applying the selection, and
forwarding media data from the selected subset of endpoints that it is currently receiving to the first endpoint, directly or through the one or more servers.

22. The method of claim 21 wherein the server is further configured to, upon receiving a request, forward the request to other servers it is connected to.

23. The method of claim 22 wherein the forwarding of the request is performed using routing information maintained by the server.

24. The method of claim 21 wherein the server is further configured to calculate the selected subset of endpoints.

25. The method of claim 24 wherein the calculation computes a list of one or more most recent active speakers.

26. The method of of claim 21 wherein the one or more servers are further configured to obtain the calculation of the selected subset from external means.

27. The method of claim 26 wherein the external means is an audio bridge.

28. The method of of claim 21 wherein request includes one or more selection parameters.

29. The method of of claim 28 wherein the selection parameters include the number of most recent active speakers.

30. Non-transitory computer readable media comprising a set of instructions to perform the methods recited in at least one of claims 15-29.
